(19) United States
(12) Patent Application Publication
(10) Pub. No.: US 2014/0185518 A1
(43) Pub. Date: Jul. 3, 2014

(54) SYSTEM AND METHOD FOR WiFi POSITIONING

(71) Applicants: Sthanunathan Eric Ramakrishnan, Bangalore (IN); Deric Wayne Waters, Dallas, TX (US)

(72) Inventors: Sthanunathan Eric Ramakrishnan, Bangalore (IN); Deric Wayne Waters, Dallas, TX (US)

(73) Assignee: TEXAS INSTRUMENTS INCORPORATED, Dallas, TX (US)

(21) Appl. No.: 13/728,961

(22) Filed: Dec. 27, 2012

(51) Int. Cl. H04W 4/02

(52) U.S. Cl. CPC H04W 4/02
USPC 370/328

(57) ABSTRACT

An aspect of the invention provides instantaneous Wi-Fi positioning that is robust to outliar APs using a recursive centroid method. It estimates user position and uncertainty based on the current list of scanned APs. Another aspect of the invention provides a Wi-Fi navigation solution that estimates good Wi-Fi positions even in the areas of low AP density and further improves robustness to outliar APs. Wi-Fi navigation solution improves the estimate of instantaneous Wi-Fi positioning by using a 4-state Kalman filter, which models user dynamics. As a result, the uncertainty estimate of the Wi-Fi positions is accurately estimated, thereby, making it suitable for blending with GNSS.

### BACKGROUND

The present invention relates to Wi-Fi based positioning systems, in particular, Wi-Fi based positioning systems for location based services.

Location based services are an emerging area of mobile applications that leverages the ability of new devices to calculate their current geographic position and report that to a user or to a service. Some examples of these services include identifying a location of a person or an object in the context of entertainment, work, health or personal life.

Wi-Fi is a mechanism that allows an electronic device to exchange data wirelessly over a computer network. Some technologies based on IEEE 802.11 standards that use Wi-Fi include Wireless Local Area Network (WLAN) and Wi-Fi direct. A Wi-Fi enabled device such as a smart phone, a personal computer, a tablet or a video game console can connect to a network resource such as the internet via a wireless network Access Point (AP). An AP or a hotspot has a range of about 20 meters indoors and a greater range outdoors. Hotspot coverage can comprise an area as small as a single room with walls that block radio signals or as large as many square miles, covered by multiple overlapping APs.

Wi-Fi provides service in private homes, high street chains and independent businesses, as well as in public spaces at Wi-Fi hotspots setup either free of charge or commercially. Organizations and businesses, such as airports, public libraries, hotels and restaurants, often provide free use hotspots to attract customers and to promote their businesses.

Wi-Fi positioning is rapidly gaining acceptance as a complement and supplement to Global Navigation Satellite Systems (GNSS) positioning for indoor environments. Global Positioning System (GPS) is a GNSS that provides autonomous geo-spatial positioning with global coverage using satellites. GNSS allows small electronic receivers to determine their location to within a few meters using time signals transmitted along a Line-Of-Sight (LOS) by radio from satellites. GPS performs poorly in urban areas where buildings block the view of satellites, and it does not provide any coverage inside of buildings.

In indoor environments or in the dense urban canyons, where the low level satellite based signals are critically compromised by obscuration and environmental degradation, Wi-Fi based positioning systems are gaining popularity. Wi-Fi hotspots are prevalent in the very areas where GNSS starts to struggle and many smart devices are already equipped with Wi-Fi technology that can support positioning applications. A conventional wireless communication system is explained with the help of FIG. 1.

FIG. 1 illustrates a conventional wireless communication system 100.

As illustrated in the figure, conventional wireless communication system 100 includes a user device 102, an AP database 104, an AP 106, an AP 108, an AP 110, an AP 112, an AP 114, an AP 116 and an AP 118.

Location of user device 102 can be determined based on the locations of AP 106-118. Unlike GPS, location of AP 106-118 is not well known. In this example, it can be determined from AP database 104, which is managed by a database vendor. Generally, a database vendor collects the location of APs by “wardriving” efforts and/or crowd sourced using mobile phones. Wardriving is the act of searching for Wi-Fi wireless networks by a person in a moving vehicle, using a smart phone, a personal computer or a Personal Digital Assistant (PDA). Wardrivers use a Wi-Fi equipped device together with a GPS device to record the location of wireless networks. The maps of known network IDs can then be used as a geo-location system—an alternative to GPS—by triangulating the current position from the signal strengths of known network IDs. The localization technique used for positioning with wireless APs is based on measuring the intensity of the received signal, indicated by its received signal strength. When a street driver finds a good GPS location, he determines that at that GPS location, there are certain number of APs and reports those APS with their respective signal strength to the database vendor. A database vendor collects this information from multiple users at different times to build up their database.

Suppose, user device 102 is a Wi-Fi enabled mobile phone. In one example, user device 102 will scan all APs (for example, AP 106-118) in its vicinity by sending a probe request to all the APs. Typically, an AP will respond with a probe response, which includes the Media Access Control (MAC) address for that AP and some other information regarding the capabilities of that AP. A MAC address is a unique identifier assigned to network interfaces for communications on the physical network segment and will uniquely identify that AP.

User device 102 receives MAC address from AP 106-118 and looks up AP database 104 to get the approximate location of each AP. Once user device 102 has approximate locations for AP 106-118, it can determine its location based on the Receive Signal Strength (RSS) for each AP. This is further explained using a conventional Wi-Fi positioning system with the help of FIG. 2.

FIG. 2 illustrates a conventional Wi-Fi positioning system.

As illustrated in the figure, a Wi-Fi positioning system 200 includes user device 102, AP database 104 and a WLAN 202. User device 102 includes a Wi-Fi Positioning Engine (PE) 204 and a Wi-Fi scan module 206. Note that for illustrative purposes, user device 102 is shown to include only two components; however, depending on the application, it may include other components.

Wi-Fi PE 204 provides scan parameter controls to Wi-Fi scan module 206 via a signal 208 for scanning the APs. Wi-Fi scan module 206 provides the scan parameters to WLAN 202 via a communication channel 216 for scanning all the APs in its vicinity. WLAN 202 sends a probe request to all the APs. Typically, an AP will respond with a probe response, which includes the Basic Service Set Identifier (BSSID) and Receive Signal Strength Indicator (RSSI) of each AP. BSSID refers to MAC address for an AP, which uniquely identifies that AP.

Wi-Fi scan module 206 receives an AP list and their corresponding RSSI from WLAN 202 via a communication channel 218. Wi-Fi scan module 206 forwards the AP list to AP database 104 via a communication channel 212 to get the approximate location of the visible APs. AP database 104 provides the AP locations to Wi-Fi scan module 206 via a communication channel 214. AP database 104 is also operable to communicate with a network (not shown) via a communication channel 220 for storing and updating the AP locations.

Wi-Fi scan module 206 forwards the AP locations and their RSSI to Wi-Fi PE 204 via a signal 210. Wi-Fi PE 204 is operable to compute the user location based on the AP locations and the RSSI for each AP.

The received signal power of an AP may be in terms of dBm (decibels above a reference level of one milliwatt), which indicates how far the AP is from user device 102. For example, if the signal power is really high, it's an indication that AP is really close by. On the other hand, low signal power indicates that the AP is really far away. Based on this information, the approximate location of user device 102 can be easily determined in a conventional Wi-Fi positioning system 200. Wi-Fi hotspot triangulation is a commonly used method of determining location on modern smart phones, as GPS does not always work in urban locations and cell-tower positioning can be inaccurate.

The user location determined based on the database of AP locations, as discussed with reference to FIG. 2 is not accurate in most cases. The accuracy of Wi-Fi positioning is affected by accuracy of AP locations in the database, in addition to the low AP visibility. These two problems relating to conventional Wi-Fi positioning system 200 will now be further discussed in detail.

Unlike GPS, where all the locations are well known, centrally controlled and transmitted, for Wi-Fi positioning, someone has to estimate the locations of existing APs and report them for storing in a database. This process inherently is error prone. In some cases, there could be huge errors, for example, if there is an AP that moves around from place to place.

As discussed earlier, the database vendors collect information from multiple users at different times to build up their database. The accuracy of the AP database depends upon the number of positions that have been entered into the database. The possible signal fluctuations that may occur in the path of the received signal can increase errors and inaccuracies in the path of the user. In certain cases, depending on the location from where the user reports it, the geometry may be poor, for example, if all the users report it from one location then it will be difficult to find that AP.

Furthermore, mobility of an AP can cause huge errors in locating that AP. An AP may be moving from one street to another and so on—for example in a case where a mobile device is able to act as an AP. A worst case scenario may be, for example, when an AP is a laptop of a traveler that is scanned in Chicago but it may originally (most other times) located at the traveler's home in Dallas. An AP, whose originally scanned location is very far from its current, is termed as an outliar AP. Therefore, if a mobile AP's reported location is unrelated to the current location then the user reporting this AP will get bad information and may cause position outliars. As mobile APs proliferate, the problem is expected to become more severe. This is further explained with the help of FIG. 3.

FIG. 3 illustrates huge outliars in a snap shot of Google map for the United States.

A map 300 illustrates an actual AP position 302 and three huge outliars 304, which are spread over in different parts of the United States. This scenario arises when the AP was reported by a user in one location (for example Dallas) and later on that AP shifted to Chicago. When a user reports this AP to the database in order to get a Wi-Fi position, he gets bad information resulting in an outliar fix. Typically, database vendors perform a consistency check of their AP database with their user's contributions periodically, but this process is dependent on some user contributing a new position with this AP to trigger the inconsistency check.

The problem of AP location being off from its current location may confuse the Wi-Fi positioning method, especially if there are very few APs detected and their location is not accurate.

Another common problem is non-uniform densities of the AP in an urban area. For example, in a down town area, some restaurants may not have the APs, while some may have APs. Low densities will degrade the performance of the Wi-Fi positioning method. Furthermore, during scanning process, all of the APs which are present may not be discovered. Generally, on an average, only a percentage of the APs will be discovered, therefore, limiting the number of available APs. Hence, low AP visibility is caused by low AP density in some parts and also fewer APs discovered during the scan process due to packet collisions, scan time limitations and high path loss, etc.

As discussed with reference to FIGS. 1-3, conventional Wi-Fi positioning systems utilize the AP location database provided by database vendors. This database is built based on the contribution from users who report APs along with their GPS locations. AP location estimates improve with contributions from different people. The database performs a consistency check over time to eliminate individual APs. For example, if a new user reports a mobile AP from a different location and the old location of that AP was very far then the old location is deleted. This is a slow process since the database has to wait for the inputs from multiple users on each AP. Furthermore, if none of the user reports it then the database still has the old location. Additionally, the database cannot remove moderate outliers, for example, an AP moving between home and office or between streets is difficult to classify as a distinct error.

A user must frequently download the AP database to get improvements provided by the database vendor. However, it is not always desirable due to the cost involved and the hassle to download the database frequently on a user's smart phone or personal computer. Hence, if the user does not update the AP database frequently, then the consistency checks performed by the database vendor to improve the database every so often are not incorporated by the user.

What is needed is a system and method to solve the problems presented by the conventional Wi-Fi positioning systems such that the method for determining user's location is robust to present lot outliers. Additionally, the system and method should work with the current set of APs irrespective of any consistency checks performed by the database vendor.

### BRIEF SUMMARY

Aspects of the present invention provide a system and method to solve the problems presented by the conventional Wi-Fi positioning systems such that the method for determining user's location is robust to present lot outliers. Further, the aspects of the present invention system work with the current set of APs irrespective of any consistency checks performed by the database vendor.

An example embodiment of the present invention is drawn to a device that includes a receiver portion, an access point locating determining portion, a device location determining portion, a distance determining portion and a thresholding portion. The receiver portion can receive a first access point signal from a first access point, can receive a second access point signal from a second access point and can receive a third access point signal from a third access point. The access point location determining portion can determine a geodetic location of the first access point, a geodetic location of the second access point and a geodetic location of the third access point. The device location determining portion can determine a location. The distance determining portion can determine a first distance between the location and the geodetic location of the first access point, can determine a second distance between the location and the geodetic location of the second access point and can determine a third distance between the location and the geodetic location of the third access point. The thresholding portion can compare the first distance with a predetermined threshold, can compare the second distance with the predetermined threshold and can compare the third distance with the predetermined threshold. The device location determining portion can further determine a modified location based on the geodetic location of the second access point and the geodetic location of the third access point when the first distance is greater than the predetermined threshold.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a conventional wireless communication system;

FIG. 2 illustrates a conventional Wi-Fi positioning system;

FIG. 3 illustrates huge outliars in a map for the United States;

FIG. 4 illustrates a device for Wi-Fi positioning, in accordance with an aspect of the invention;

FIG. 5 illustrates a flow chart for recursive centroid method, in accordance with an aspect of the invention;

FIG. 6 illustrates a snap shot of a typical downtown area;

FIG. 7 illustrates a Wi-Fi Position Engine, in accordance with an aspect of the invention;

FIG. 8 illustrates an example embodiment of uncertainty calculation, in accordance with an aspect of the invention; and

FIG. 9 illustrates an example performance of Wi-Fi navigation solution, in accordance with an aspect of the invention.

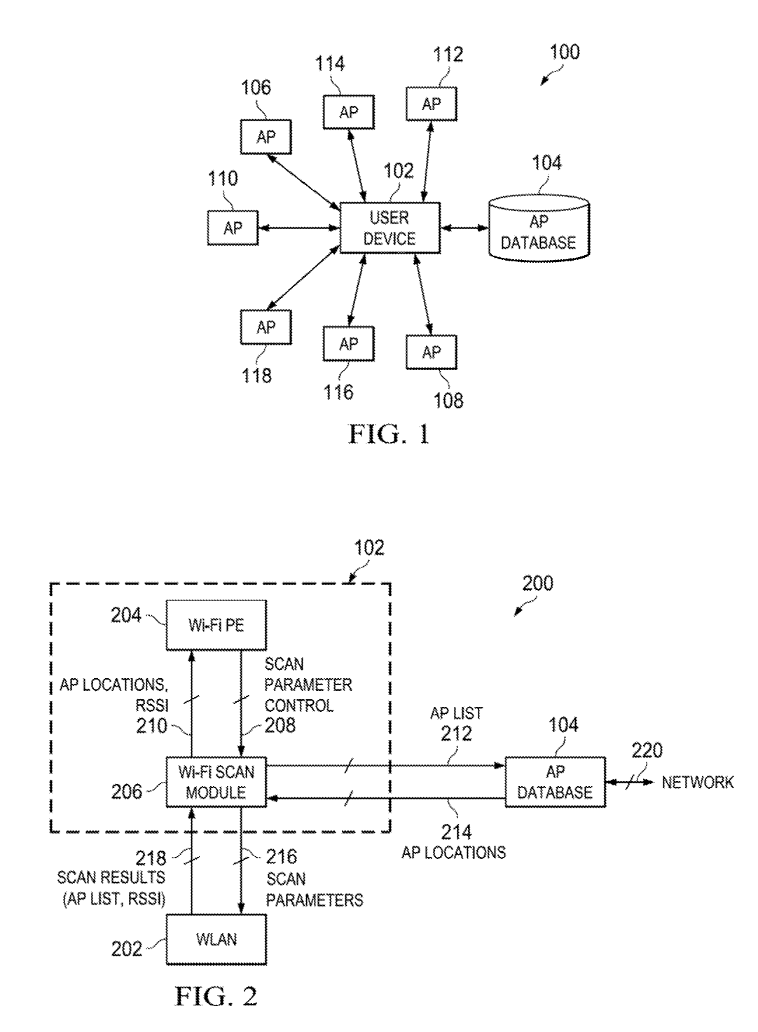

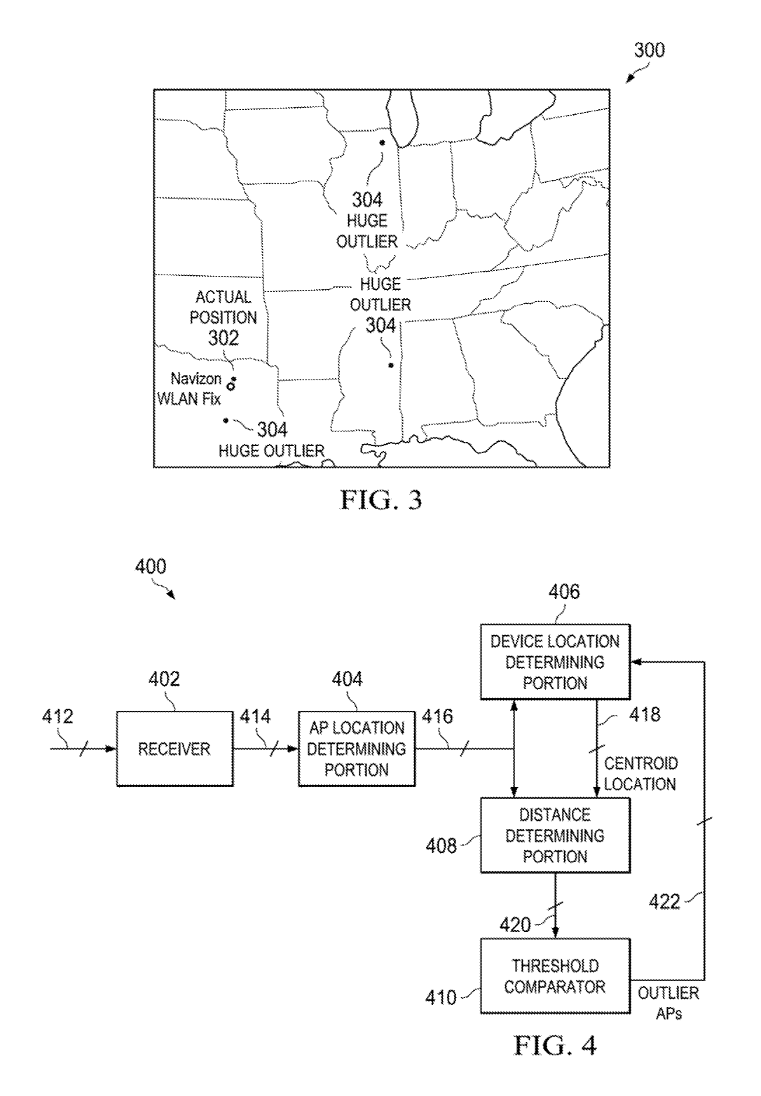

### DETAILED DESCRIPTION

The present invention overcomes the problems encountered by the conventional Wi-Fi communication systems by providing a solution at the user site such that the method for determining user's location is robust to present outliers. Aspects of the invention provide reliable and accurate Wi-Fi positioning that is robust to low AP visibility problems and also to inaccurate AP positions in the database due to mobile APs.

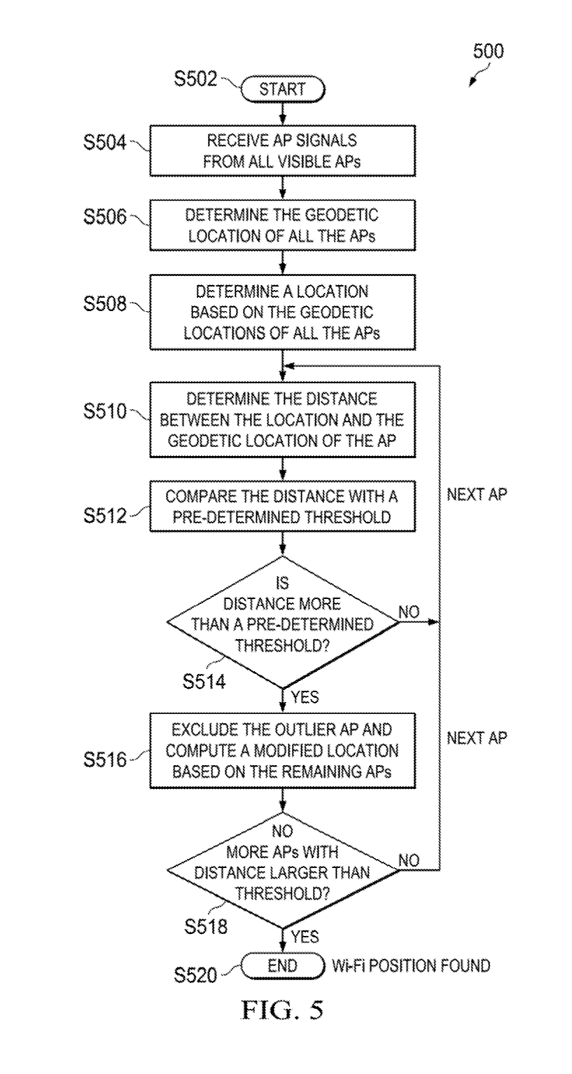

An aspect of the invention provides a recursive centroid method to estimate a user's location. The method begins by calculating weighted centroid of all visible APs. A centroid of a plane figure or a two dimensional shape X is the average (arithmetic mean) of all points of X. As an example, a centroid is calculated by taking an average of all the AP locations, which may be obtained from an AP database. In one example embodiment, centroid calculation is weighted based on the RSSI from the APs. Finally, the distance of all the visible APs is determined from the resulting centroid position. If the distance of an AP from the centroid position is more than a pre-determined value then that AP (the one with the maximum distance from the centroid position) is declared as an outlier and the centroid is calculated again with the remaining APs. This process is repeated until the distance of all the visible APs is less than the pre-determined distance. The resulting centroid is the desired Wi-Fi position. This is further explained with the help of FIGS. 4 and 5.

FIG. 4 illustrates a device for Wi-Fi positioning, in accordance with an aspect of the invention.

As illustrated in the figure, a device 400 includes a receiver 402, an AP location determining portion 404, a device location determining portion 406, a distance determining portion 408 and a threshold comparator 410. In this example, receiver 402, AP location determining portion 404, device location determining portion 406, distance determining portion 408 and threshold comparator 410 are distinct elements. However, in some embodiments, at least two of receiver 402, AP location determining portion 404, device location determining portion 406, distance determining portion 408 and threshold comparator 410 may be combined as a unitary element. In other embodiments, at least one of receiver 402, AP location determining portion 404, device location determining portion 406, distance determining portion 408 and threshold comparator 410 may be implemented as a computer having stored therein non-transient, tangible computer-readable media for carrying or having computer-executable instructions or data structures stored thereon. Such non-transient, tangible computer-readable media can be any available media that can be accessed by a general purpose or special purpose computer. Non-limiting examples of non-transient, tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a non-transient, tangible computer-readable media. Combinations of the above should also be included within the scope of non-transient, tangible computer-readable media. In one example, device 400 is similar to device 102 that communicates with AP 106-118 and AP database 104.

Receiver 402 is operable to receive AP signals from all visible APs via a communication channel 412. In one example embodiment, receiver 402 scans the APs in its vicinity by sending a probe request to all the APs. Each AP responds with a probe response that includes the MAC address for that AP and some other parameters which define that AP's capabilities. In one example embodiment, receiver 402 may include Wi-Fi scan module 206 for scanning the APs.

AP location determining portion 404 is operable to determine location of each AP based on the information received from receiver 402 via a signal 414. In one example embodiment, AP location determining portion 404 communicates with a database, such as AP database 104, to determine the location of each AP based on the MAC address of that AP. AP location determining portion 404 provides the location of each AP to device location determining portion 406 and distance determining portion 408 via a signal 416.

Device location determining portion 406 is operable to determine the location of device 400 based on AP locations received from AP location determining portion 404. In an example embodiment, the location of device 400 is calculated by computing a centroid of all the AP locations, which is an average of the locations of all the available APs. In one example embodiment, centroid calculation is weighted based on the RSSI from the APs. The centroid location is forwarded to distance determining portion 408 via a signal 418.

Distance determining portion 408 is operable to compute the distance of all the APs from the centroid location based on the AP locations provided by AP location determining portion 404. The distance between each AP and the centroid location is forwarded to threshold comparator 410 via a signal 420.

Threshold comparator 420 is operable to compare the distance between each AP and the centroid location with a pre-determined value to determine which APs can be declared outliars within the vicinity of device 400. If the distance between an AP and the centroid location is more than the pre-determined value, then that AP is declared as an outliar. Threshold comparator 420 forwards the list of outliar APs to device location determining portion 406 via a signal 422.

Device location determining portion 406 removes only the worst outlier APs from the AP list and re-calculates the centroid again with the remaining APs. A new centroid location for the remaining APs is forwarded to distance determining portion 408, which calculates the distance of all the APs again from the new centroid location. Threshold comparator 420 compares the distances of remaining APs with the same pre-determined value to declare a new list of outliar APs. This process repeats until the distance of all the visible APs is less than the pre-determined value or the number of APs is less than some threshold. The resulting centroid for which the distance of all the visible APs is less than the pre-determined value is the desired Wi-Fi position. This recursive process of generating a centroid location for Wi-Fi positioning, in accordance with an aspect of the invention, is discussed further with the help of FIG. 5.

FIG. 5 illustrates a flow chart for recursive centroid method, in accordance with an aspect of the invention.

The recursive centroid method starts when the location of a user device needs to be determined (S502).

First, AP signals are received from all visible Aps (S504). For example, returning to FIG. 4, receiver 402 receives AP signals from all visible APs.

Returning to FIG. 5, the geodetic locations of the APs are then determined (S506). For example, as shown in FIG. 4, AP location determining portion 404 determines the geodetic location of all the APs.

Returning to FIG. 5, the location is then determined based on the geodetic locations of the APs (S508). For example, as shown in FIG. 4, device location determining portion 406 computes a centroid location based on the geodetic location of all the APs. In one example embodiment, the centroid location is calculated by averaging all the AP locations.

Returning to FIG. 5, a distance is computed between the centroid location and the geodetic location for each AP (S510). For example, as shown in FIG. 4, distance determining portion 408 computes a distance between the centroid location and the geodetic location for each AP.

Returning to FIG. 5, the distance between the centroid location and the geodetic location for each AP is compared a pre-determined threshold to determine the outliar APs (S512). For example, as shown in FIG. 4, threshold comparator 410 compares distance between the centroid location and the geodetic location for each AP with a pre-determined threshold to determine the outliar APs.

Returning to FIG. 5, it is then determined whether the distance is more than the pre-determined threshold (S514).

If the new distance is less than or equal to the pre-determined threshold (NO at S514), then a distance is computed between the centroid location and the geodetic location for the next AP (S510).

If the new distance is more than the pre-determined threshold (YES at S514), then the AP is determined to be an outlier and a modified location is determined (S516). For example, as shown in FIG. 4, threshold comparator 410 declares that AP is an outliar and device location determining portion 406 computes a modified location based on the remaining APs.

Returning to FIG. 5, it is then determined whether there are any more APs with a distance larger than the predetermined threshold (S518). If there are no more APs with their distance more than the pre-determined threshold (S518), the final centroid location is the desired Wi-Fi position (S520).

If there are more APs with their distance more than the pre-determined threshold (NO at S518), then a distance is computed between the centroid location and the geodetic location for the next AP (S510).

If there are no more APs with their distance more than the pre-determined threshold (YES at S518), then the final centroid location is the desired Wi-Fi position (S520).

As discussed with reference to FIGS. 4-5, aspects of the invention provide a recursive centroid method to provide an overall good positioning accuracy by removing outliar APs based on a threshold distance.

Another example of removing the outliar APs may be by making a list of APs from the database and sorting the database in some order such that the outliers can be differentiated from the list based on certain criterion.

Another way of removing outliers is to determine a cluster and then remove the outlier APs. One possible method is to determine a median position based on the APs. In one example a median position of the APs along both x and y directions may be determined. Then, any APs that are far away, e.g., farther than a predetermined threshold, from the median location on x or y directions can then be declared as outliers.

Recursive centroid method, however, presents a simpler solution.

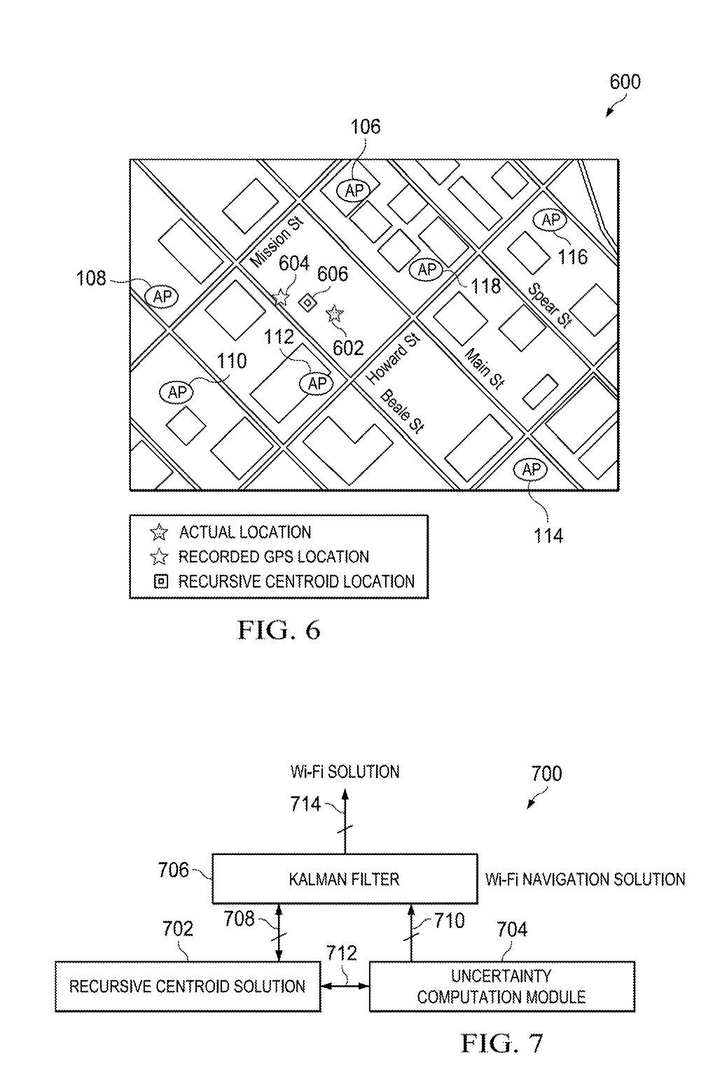

Typical range of Wi-Fi is 100 meters maximum. Assuming that the location of AP itself is off by 100 meters, in an example embodiment, any AP that is more than 200 meters away from the user may be considered an outlier, where 200 meters is the pre-determine threshold value. The outlier AP with the max distance is deleted and the recursive centroid is calculated again until the solution converges to all APs within 200) meters or when the number of APs falls below a threshold. This is explained further with the help of a FIG. 6.

FIG. 6 illustrates a snap shot of a typical downtown area.

As illustrated in the figure, a map 600 includes APs 106-118 scattered through the downtown area, an actual location 602, a recorded GPS location 604 and a recursive centroid location 606 for a user device. In one example, the user device is device 400.

For purposes of discussion, AP 106, AP 108, AP 110, AP 112 and AP 118 are less than 200 meters from recorded GPS location 604. Further, for purposes of discussion, AP 114 is 250 meters and AP 116 is 220 meters away from recorded GPS location 604. Assuming the pre-determined threshold is 200 meters, threshold comparator 410 will eliminate AP 114 in the first round (S516 of FIG. 5) since it is 250 meters away and device location determining portion 406 will compute modified centroid location with AP 106, AP 108, AP 110, AP 112, AP 116 and AP 118. In the next round, threshold comparator 410 will eliminate AP 116 since it is 220 meters away and device location determining portion 406 will compute modified centroid location with AP 106, AP 108, AP 110, AP 112 and AP 118. Threshold comparator 410 will again compare the distances of AP 106. AP 108, AP 110. AP 112 and AP 118 from the modified centroid location. Since all the remaining APs are less than the pre-determined threshold (200 meters) away from the centroid location, the solution converges and the modified centroid location is recursive centroid location 606. Note that recursive centroid location 606 is closer to actual location 602 as compared to recorded GPS location 604, since GPS performance is critically compromised by obscuration and environmental degradation in deep urban canyons.

Note that the recursive centroid method can be implemented either on a server or on a user's device. As an example, a list of APs can be sent to a server, such as the server of an AP service provider. The server can then compute the user location based on the recursive centroid method and provide an estimated user location.

As discussed with reference to FIGS. 4-6, an aspect of the invention takes care of robust outliars using the recursive centroid method. In case of low AP visibility, the recursive centroid method may not work efficiently, which assumes that there is enough number of APs that are good to isolate bad APs. Low number of APs may cause scattered user locations or gaps in locations. Another aspect of the invention solves the low AP density problem by providing Wi-Fi navigation, which is discussed below.

Another aspect of the invention uses a position filtering method that models user dynamics, which helps propagate the Wi-Fi fix from recursive centroid method. To determine a user's position, the proposed method tries to navigate the street, which may include both high density and low density areas. Example embodiments may use an estimator that estimates a current position based on current states along with uncertainties associated with the current states. Any known estimator may be used, a non-limiting example of which includes a Kalman filter. In an example embodiment, a four state Kalman filter with two positions along the 2-D plane and two velocities is used to predict user's location.

A Kalman filter produces an optimal state of a system based on recursive measurements of noisy input data. The method works in a two-step process. In the prediction step, the Kalman filter produces estimates of the true unknown values, along with their uncertainties. Once the outcome of the next measurement is observed, these estimates are updated using a weighted average, with more weight being given to estimates with higher certainty. This method produces estimates that tend to be closer to the true unknown values than those that would be based on a single measurement alone or the model predictions alone.

The Kalman filter method tries to determine user's location as well as user's velocity. In the case when there are no APs visible for whatever reason, a user's current location can be determined from his past location plus his displacement that is equal to velocity multiplied by time. Therefore, the user's location can be determined based on the past history even if poor information is available about his current status. Since user's velocity is directly not known, in one example embodiment, Kalman filter will try to extract user's velocity from user's location. Modeling user's velocity helps propagating the Wi-Fi fix when number of APs is low. Furthermore, it reduces Wi-Fi positioning scatter because the new information (user's velocity) and old information (user's location) is fused together to get a filtered fix.

Aspects of the invention provide instantaneous Wi-Fi positioning using recursive centroid method in combination with Wi-Fi navigation solution as discussed with the help of FIG. 7.

FIG. 7 illustrates a Wi-Fi PE, in accordance with an aspect of the invention.

As illustrated in the figure, a Wi-Fi PE 700 includes a recursive centroid solution 702, an uncertainty computation module 704 and a Kalman filter 706. In this example, recursive centroid solution 702, uncertainty computation module 704 and Kalman filter 706 are distinct elements. However, in some embodiments, at least two of recursive centroid solution 702, uncertainty computation module 704 and Kalman filter 706 may be combined as a unitary element. In other embodiments, at least one of recursive centroid solution 702, uncertainty computation module 704 and Kalman filter 706 may be implemented as a computer having stored therein non-transient, tangible computer-readable media for carrying or having computer-executable instructions or data structures stored thereon.

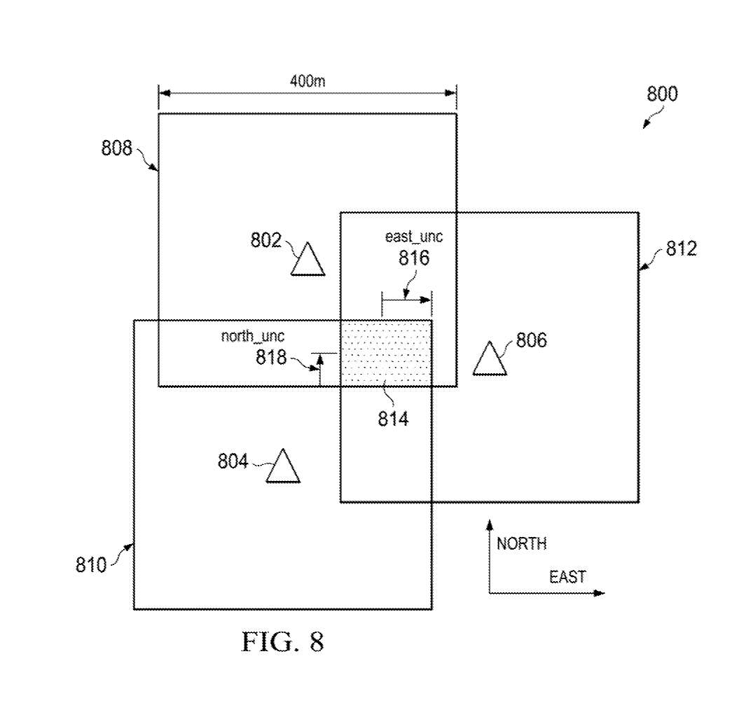

Recursive centroid solution 704 bi-directionally communicates with Kalman filter 706 via a signal 708 and with uncertainty computation module 704 via a signal 712. Uncertainty computation portion 706 communicates with Kalman filter 706 via a signal 710 in order to provide uncertainty values for Kalman filter computation. Uncertainty computation module 704 is further discussed with the help of FIG. 8.

FIG. 8 illustrates an example embodiment of uncertainty calculation, in accordance with an aspect of the invention.

As illustrated in the figure, an AP 802 has a visibility area 808, an AP 804 has a visibility area 810 and an AP 806 has a visibility area 812. An overlapping area 814 represents an uncertainty region that is feasible area for Wi-Fi positions. An east uncertainty 816 represents uncertainty in the cast direction that is half of the overlapping area 814. Similarly, a north uncertainty 818 represents uncertainty in the north direction that is half of the overlapping area 814.

As an example, the visibility area of an AP is represented by a square with half side equal to 200 meters since the square assumption makes calculation for uncertainty easier than that of a circle. As illustrated in the figure, the visibility areas for AP 802, AP 804 and AP 806 overlap in overlapping area 814. Overlapping area 814 represents feasible area for Wi-Fi positions, where the Wi-Fi uncertainty is half the side of overlapping area 814. The Wi-Fi uncertainty computed by instantaneous Wi-Fi positioning using recursive centroid method is forwarded to Kalman filter 706 to compute the Wi-Fi navigation solution.

Kalman filter 706 is operable to receive Wi-Fi fixes from recursive centroid solution 702 and uncertainty computation from uncertainty computation module 704 to provide a Wi-Fi navigation solution via a signal 714.

In one example embodiment, Kalman filter prediction is used to remove some really bad APs initially. As an example, if Kalman filter 706 estimates that an AP is 500 meters away from user's location then that AP can be unilaterally removed without waiting for the centroid calculation.

In another example embodiment, based on the individual recursive centroid based Wi-Fi positions, Kalman filter 706 filters out and extracts the user's velocity and predicts the position of the user. Hence, even if the number of APs is low, it still provides a Wi-Fi fix. Furthermore, it reduces scatter.

In one example embodiment, an estimate of user's first position can be determined from Kalman filter 706 instead of recursive centroid solution 704. Kalman filter 706 will help filter out really bad outliars in the first round and then recursive centroid solution 704 can take over.

In some cases GPS can be blended with Wi-Fi positioning. As an example, if GPS needs help in determining a location and there are not enough APs, Kalman filter enables to determine Wi-Fi fixes during low AP visibility to help GPS problems. In other words, a Kalman filter may help in cases where Wi-Fi position determination was good in the past, but is currently bad and the GPS fixes are currently bad. In such cases, a Kalman-filter-predicted user location from a Wi-Fi position determining system can assist locations with poor GPS signals. These Wi-Fi fixes may then help improve poor GPS fixes using GPS and Wi-Fi blending.

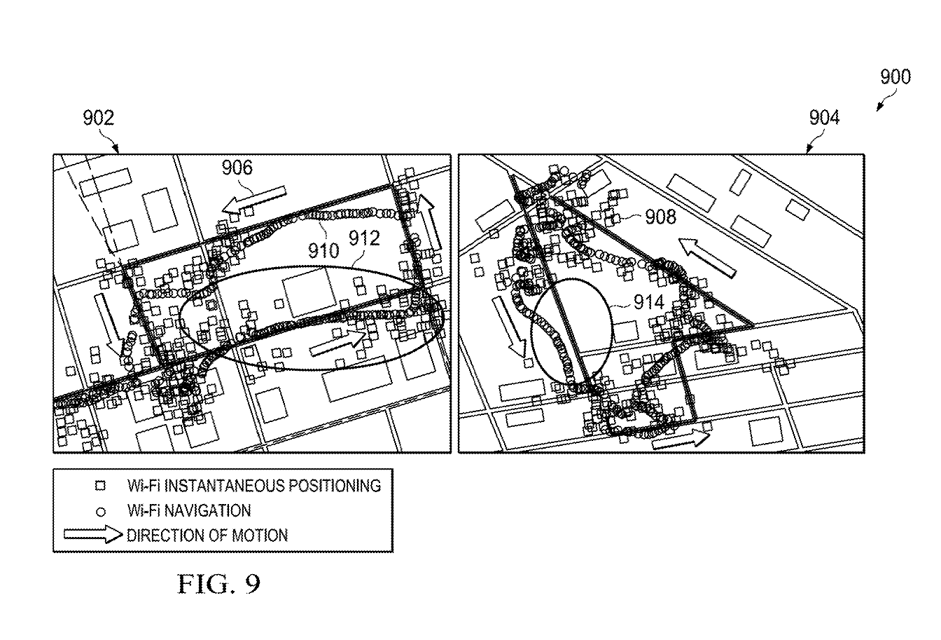

As an example, in one scenario, Wi-Fi positioning can be turned on when an urban canyon is detected by the GNSS. Wi-Fi positioning can get help from GPS for initial starting or determine its own centroid and then use Kalman filter. In order to use Wi-Fi as a navigation technology, navigation information from sporadic fixes is extracted and Wi-Fi based navigation is enabled. Sporadic Wi-Fi fixes are improved by smooth navigation solution. This is further explained with the help of FIG. 9.

FIG. 9 illustrates an example performance of Wi-Fi navigation solution.

FIG. 9 illustrates a scenario 902 and a scenario 904 to illustrate how Wi-Fi fixes are improved by smooth navigation solution. Direction of motion is indicated by an arrow 906 in both the scenarios. Squares 908 represent Wi-Fi instantaneous positioning, while circles 910 represent Wi-Fi navigation solution.

As illustrated by a circled area 912 and a circled area 914, instantaneous Wi-Fi positioning cannot easily determine a user's location due to a low number of APs. However, Wi-Fi navigation solution can determine a user's location using a Kalman filter even with fewer APs. Hence, Wi-Fi navigation solution provides Wi-Fi positioning even in regions where there are low or no fixes from instantaneous Wi-Fi positioning. Additionally, scatter of Wi-Fi positioning is reduced significantly, thereby increasing Wi-Fi positioning accuracy.

In one scenario, as a user is traveling, he may encounter many good APs and couple of bad APs. As discussed earlier, when there are a large number of good APs and a small number of bad APs, it is easier to figure out the outliars. As he continues to walk, there may be more bad APs than good APs. In this situation, it is difficult to figure out which bad APs are outliars. One solution could be to use Kalman filter to determine the outliars but it requires the user position to be accurate. If the user is going to be in a low AP density area for a long time, then the Kalman filter may be uncertain. Additionally, if there are no more new APs, the Kalman filter cannot determine with high certainty that its estimation is correct. Therefore, detection of outliars based on Kalman filter in this situation is not reliable.

In one embodiment, when there are a large number of APs, any outliars detected can be blacklisted. In other words, those outliar APs are marked as bad APs so they are not used in the future. In case when the AP density is low, and those marked APs are encountered, they are not used in the Wi-Fi positioning calculation. This methodology will result in more accurate positioning.

In one embodiment, the AP database is searched in a small tile area around the current location. Any Aps outside the small tile area are ignored. This automatically removes the outliers. The size of the tile area may be predetermined. As the area increases, there will be an increased likelihood of obtaining location information from multiple APs. However, as the area increases, there will additionally be an increased likelihood of obtaining location information from an unwanted outlier. On the other hand, as the area decreases, there will be a corresponding decrease in the likelihood of obtaining location information from multiple APs. Yet, as the area decreases, there will additionally be a corresponding decrease in the likelihood of obtaining location information from an unwanted outlier.

As discussed with the help of FIGS. 4-9, an aspect of the invention provides instantaneous Wi-Fi positioning that is robust to outliar APs using a recursive centroid method. It estimates user position and uncertainty based on the current list of scanned APs. Another aspect of the invention provides a Wi-Fi navigation solution that estimates good Wi-Fi positions even in the areas of low AP density and further improves robustness to outliar APs. Wi-Fi navigation solution improves the estimate of instantaneous Wi-Fi positioning by using a 4-state Kalman filter, which models user dynamics. As a result, the uncertainty estimate of the Wi-Fi positions is accurately estimated, thereby, making it suitable for blending with GNSS.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device comprising:
a receiver portion operable to receive a first access point signal from a first access point, to receive a second access point signal from a second access point and to receive a third access point signal from a third access point;
an access point location determining portion operable to determine a geodetic location of the first access point, a geodetic location of the second access point and a geodetic location of the third access point;
a device location determining portion operable to determine a location;
a distance determining portion operable to determine a first distance between the location and the geodetic location of the first access point, to determine a second distance between the location and the geodetic location of the second access point and to determine a third distance between the location and the geodetic location of the third access point; and
a thresholding portion operable to compare the first distance with a predetermined threshold, to compare the second distance with the predetermined threshold and to compare the third distance with the predetermined threshold,
wherein said device location determining portion is further operable to determine a modified location based on the geodetic location of the second access point and the geodetic location of the third access point when the first distance is greater than the predetermined threshold.

2. The device of claim 1, wherein the first access point signal comprises a Wi-Fi signal.

3. The device of claim 1, wherein said device location determining portion comprises a position estimator operable to estimate the modified location based on current states along with uncertainties associated with the current states.

4. The device of claim 3,
wherein said position estimator comprises a Kalman filter, and
wherein said Kalman filter is operable to determine the location and a velocity at the location.

5. The device of claim 1, wherein said device location determining portion is operable to determine the location based on the geodetic location of the first access point, the geodetic location of the second access point and the geodetic location of the third access point.

6. The device of claim 1, wherein said device location determining portion is operable to determine the location as the median of the geodetic location of the first access point, the geodetic location of the second access point and the geodetic location of the third access point.

7. A method of using a first access point, a second access point and a third access point, the first access point providing a first access point signal, the second access point providing a second access point signal, the third access point providing a third access point signal, said method comprising:
receiving, via a receiver portion, a first access point signal from a first access point;
receiving, via the receiver portion, a second access point signal from a second access point;
receiving, via the receiver portion, a third access point signal from the third access point;
determining, via an access point location determining portion, a geodetic location of the first access point,
determining, via the access point location determining portion, a geodetic location of the second access point;
determining, via the access point location determining portion, a geodetic location of the third access point;
determining, via a device location determining portion, a location;
determining, via a distance determining portion, a first distance between the location and the geodetic location of the first access point;
determining, via the distance determining portion, a second distance between the location and the geodetic location of the second access point;
determining, via the distance determining portion, a third distance between the location and the geodetic location of the third access point;
comparing, via a thresholding portion, the first distance with a predetermined threshold;
comparing, via the thresholding portion, the second distance with the predetermined threshold;
comparing, via the thresholding portion, the third distance with the predetermined threshold; and
determining, via the device location determining portion, a modified location based on the geodetic location of the second access point and the geodetic location of the third access point when the first distance is greater than the predetermined threshold.

8. The method of claim 7, wherein the first access point signal comprises a Wi-Fi signal.

9. The method of claim 7, wherein said determining, via the device location determining portion, a modified location based on the geodetic location of the second access point and the geodetic location of the third access point when the first distance is greater than the predetermined threshold comprises estimating, via a position estimator, the modified location based on current states along with uncertainties associated with the current states.

10. The method of claim 9, further comprising:
determining, via the position estimator, the location and a velocity at the location,
wherein the position estimator comprises a Kalman filter.

11. The method of claim 7, wherein said determining, via a device location determining portion, a location comprises determining the location based on the geodetic location of the first access point, the geodetic location of the second access point and the geodetic location of the third access point.

12. The method of claim 7, wherein said determining, via a device location determining portion, a location comprises determining the location as the median of the geodetic location of the first access point, the geodetic location of the second access point and the geodetic location of the third access point.

13. A non-transitory, tangible, computer-readable media having computer-readable instructions stored thereon, the computer-readable instructions being capable of being read by a computer and being capable of instructing the computer to perform the method comprising:
receiving, via a receiver portion, a first access point signal from a first access point;
receiving, via the receiver portion, a second access point signal from a second access point;
receiving, via the receiver portion, a third access point signal from the third access point;
determining, via an access point location determining portion, a geodetic location of the first access point,
determining, via the access point location determining portion, a geodetic location of the second access point;
determining, via the access point location determining portion, a geodetic location of the third access point;
determining, via a device location determining portion, a location based on the geodetic location of the first access point, the geodetic location of the second access point and the geodetic location of the third access point;
determining, via a distance determining portion, a first distance between the location and the geodetic location of the first access point;
determining, via the distance determining portion, a second distance between the location and the geodetic location of the second access point;
determining, via the distance determining portion, a third distance between the location and the geodetic location of the third access point;
comparing, via a thresholding portion, the first distance with a predetermined threshold;
comparing, via the thresholding portion, the second distance with the predetermined threshold;
comparing, via the thresholding portion, the third distance with the predetermined threshold; and
determining, via the device location determining portion, a modified location based on the geodetic location of the second access point and the geodetic location of the third access point when the first distance is greater than the predetermined threshold.

14. The non-transitory, tangible, computer-readable media of claim 13, wherein the computer-readable instructions are capable of instructing the computer to perform the method such that first access point signal comprises a Wi-Fi signal.

15. The non-transitory, tangible, computer-readable media of claim 13, wherein the computer-readable instructions are capable of instructing the computer to perform the method such that said determining, via the device location determining portion, a modified location based on the geodetic location of the second access point and the geodetic location of the third access point when the first distance is greater than the predetermined threshold comprises estimating, via a position estimator, the modified location based on current states along with uncertainties associated with the current states.

16. The non-transitory, tangible, computer-readable media of claim 15, wherein the computer-readable instructions are capable of instructing the computer to perform the method further comprising:
determining, via the position estimator, the location and a velocity at the location,
wherein the position estimator comprises a Kalman filter.

17. The non-transitory, tangible, computer-readable media of claim 13, wherein the computer-readable instructions are capable of instructing the computer to perform the method such that said determining, via a device location determining portion, a location comprises determining the location based on the geodetic location of the first access point, the geodetic location of the second access point and the geodetic location of the third access point.

18. The non-transitory, tangible, computer-readable media of claim 13, wherein the computer-readable instructions are capable of instructing the computer to perform the method such that said determining, via a device location determining portion, a location comprises determining the location as the median of the geodetic location of the first access point, the geodetic location of the second access point and the geodetic location of the third access point.
